(19) United States
(12) Patent Application Publication
(10) Pub. No.: US 2007/0067780 A1
(43) Pub. Date: Mar. 22, 2007

(54) Method and system for asynchronous eventing over the internet

(75) Inventors: Praveen Kumar, San Jose, CA (US); Yu Song, Milpitas, CA (US); Alan Messer, Los Gatos, CA (US); Doreen Cheng, San Jose, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/354,784

(22) Filed: Feb. 14, 2006

Related U.S. Application Data
(60) Provisional application No. 60/711,155, filed on Aug. 24, 2005.

(51) Int. Cl. G06F 9/46

(52) U.S. Cl. 719/318

(57) ABSTRACT

An eventing method and system is provided that enables resource-constrained CE devices, at home, away from home, on-the-go, or behind a firewall, to communicate through asynchronous events with each other and/or with other type electronic devices, at home or on the Internet. Further, a scalable distributed system is provided that supports asynchronous eventing over the Internet efficiently and at low cost.

### RELATED APPLICATION

Priority is claimed from U.S. provisional patent application Ser. No. 60/711,155 filed on Aug. 24, 2005, which is incorporated herein by reference.

### FIELD OF THE INVENTION

The present invention relates generally to asynchronous eventing and more particularly to asynchronous eventing over the Internet.

### BACKGROUND OF THE INVENTION

Mechanisms for asynchronous eventing in the home networking middleware such as UPnP (Universal Plug-in and Play) are designed for CE (Consumer Electronics) devices. However, such mechanisms only allow devices to communicate through a local area network (LAN). There are no provisions for such devices to communicate events across the Internet. As a result, it is not possible to use these mechanisms to send/receive events to/from devices behind firewalls.

Asynchronous eventing has been in existence since the dawn of computers. The pervasiveness of the Internet has ignited a new wave of research and development on asynchronous eventing across the Internet, e.g. Microsoft Herald, SIENA from University of Colorado and Gnutella. However these prior art methods are targeted at applications running general-purpose computers. As a result, they require large amounts of storage, computation, and/or communication resources and are not suitable for CE devices which must be low cost. In addition to the complexity and high cost of these systems, another drawback of these general purpose eventing systems is that require change of existing Internet infrastructure to add overlay network.

Most home devices are behind firewalls, invisible to devices/systems on the Internet. Being able to deliver notifications to devices behind firewalls from anywhere on the Internet is critical to smart home applications where devices can roam from one network to another while communicating with devices at home; however that has not been the concern of the above prior art.

Instant messaging (IM) systems, such as AIM, MS Messenger, and Yahoo Messenger, are provider specific, i.e. one provider's IM cannot talk to the other providers' IM. Although recently messaging systems such as AOL/ICQ and Yahoo/Trillion enables IM systems from different providers to communicate with each other, using IM still requires keeping connections to the Internet always open. For resource limited CE devices, keeping a connection open is a heavy resource consumption task. In addition, since CE devices can roam from one network to another, without IP infrastructure change (e.g., Mobile IP), keeping an always-on connection for a roaming CE device involves complex schemes in the network and may not be possible in many circumstances.

Email is increasingly becoming a popular venue to deliver messages over the Internet. However, email can not guarantee timely delivery.

SMS/MMS (Simple Messaging System/Multimedia Messaging System) is another popular message delivery mechanism in the cellular networks. However, SMS/MMS has serveral limitations. First, SMS has message size constraints such that long messages are truncated. MMS has the similar limitation with bigger sizes. Second, SMS/MMS can only be used between cell phones, and from applications to cell phones. To receive the message, a CE device must subscribe to a cellular provider.

### BRIEF SUMMARY OF THE INVENTION

In one embodiment the present invention provides an eventing method and system that enables resource-constrained CE devices, at home, away from home, on-the-go, behind a firewall, etc., to communicate through asynchronous events with each other and/or with other type electronic devices, at home, on the Internet, etc. Further, a scalable distributed system is provided that supports asynchronous eventing over the Internet efficiently and at low-cost.

In one implementation, the present invention provides a method for asynchronous eventing between a client and a server in a network, comprising the steps of: in a subscription phase, the client sending a subscription request to the server to express interest in receiving notifications associated with one or more particular events that may asynchronously occur on the server; and after a successful subscription, in a notification phase, the server notifying each client that has subscribed for a particular type of event.

The network can further includes multiple clients, such that: the subscription phase further includes the steps of each client sending a subscription request to the server to express interest in receiving notifications associated with particular events that may asynchronously occur on the server; and the notification phase further includes the steps of, after successful subscription, the server notifying each client that has subscribed for a particular type of event.

The network can further include multiple servers, such that: the subscription phase further includes the steps of the client sending a subscription request to each server to express interest in receiving notifications associated with particular events that may asynchronously occur on that server; and the notification phase further includes the steps of, after successful subscription, each server notifying each client that has subscribed for a particular type of event.

When an asynchronous event occurs, the steps of notification further include the steps of the server publishing the event and sending a notification directly to the client. In another case, when an asynchronous event occurs, the steps of notification further include the steps of the client polls for notifications directly from the server. In another case, when an asynchronous event occurs, the step of notification further include the steps of the server publishing the event on a notification center in the network, wherein the notification center sends a notification to the client. Yet, in another case, when an asynchronous event occurs, the steps of notification further include the steps of the server publishing the event on a notification center in the network, wherein the client polls the notification center for the notification. Further, in one version, the server notifies the client via a direct communication link between the client and the server.

In another implementation of the eventing method of the present invention, the network further includes a notification center, such that: the subscription phase further includes the steps of: the client sending a subscription request to the notification center to request notifications for one or more events from one or more servers; and the notification phase further includes the steps of: after a successful subscription, the client polling the notification center for notification. Alternatively, in the notification phase, the notification center pushes the notification to the client.

The eventing method can include the steps of: each server sending a subscription request to the notification center for permission to publish events on the notification center; after a successful server subscription, the server publishing events on the notification center as they occur on the server; and the notification center notifying each client of published notifications that the client subscribed for with the notification center. The notification center can notify each client of published notifications that the client subscribed for, as the event is published by the server.

In one case, the client and server use direct communication. In another case, the server and the client use indirect communication. The network can include the Internet such that the client and server are connected to the Internet. The network can also include a local area network (LAN) such that the client and the server are connected to the LAN.

In another aspect, an embodiment of an asynchronous eventing system according to the present invention comprises: a client and server, wherein the client sends a request to a server to request subscription to event notification for one or more particular events that may asynchronously occur on the server, the request including request ID that identifies the requested event type, and listener information that identifies a listener for the server to send a reply to the request; if the subscription is successful, the server maintains the request ID and the listener information and sends a subscription reply including the request ID to the client to indicate whether the subscription is successful, wherein if the subscription is successful, thereafter when an event corresponding to the request ID occurs on the server, for each and every listener that has subscribed to the event, the server establishes a connection to the listener and sends a notification together with the request ID to the listener.

These and other features, aspects and advantages of the present invention will become understood with reference to the following description, appended claims and accompanying figures.

### BRIEF DESCRIPTION OF THE DRAWINGS

FIG. 1 shows an example system implementing a handshaking eventing protocol (Scheme 1) according to a first embodiment of the present invention.

FIG. 2 shows an example system implementing a handshaking eventing protocol (Scheme 2) according to a second embodiment of the present invention.

FIG. 3 shows an example system implementing a handshaking eventing protocol (Scheme 3) according to a third embodiment of the present invention.

FIG. 4 shows an example system implementing a handshaking eventing protocol (Scheme 4) according to a fourth embodiment of the present invention.

FIG. 5 shows an example system implementing a handshaking eventing protocol (Scheme 5) according to a fifth embodiment of the present invention.

FIG. 6 shows an example system implementing a handshaking eventing protocol (Scheme 6) according to a sixth embodiment of the present invention.

### DETAILED DESCRIPTION OF THE INVENTION

Almost all smart-home applications in the areas of sharing digital assets among relatives and friends, and monitoring and/or controlling home CE devices for home security, entertainment, automation, and healthcare, depend on the devices being able to send/receive asynchronous events (also known as eventing) to/from each other, and/or to/from other digital devices such as servers of an ISP (Internet Service Provider) or ASP (Application Service Provider). Eventing is a core communication mechanism of these applications.

Asynchronous eventing among electronic devices over the Internet is a necessary mechanism to enable applications such as sharing digital assets among relatives and friends, and monitoring and/or controlling home consumer electronic (CE) devices for home security, entertainment, automation, and healthcare. Supporting the eventing efficiently and at low cost is critical for the success of CE devices at the market place in an era of digital homes.

In one embodiment, the present invention provides an eventing method that enables resource-constrained CE devices, at home, away from home, on-the-go, behind a firewall, etc., to communicate through asynchronous events with each other and/or with other type electronic devices, at home, on the Internet, etc. Further, the present invention provides a scalable distributed system that supports asynchronous eventing over the Internet efficiently and at low cost.

In one version, the present invention enables CE devices to communicate events at low cost over the Internet and through firewalls. The commonly assigned patent application, titled “An authentication method and system for asynchronous eventing over the Internet”, attorney docket SAM2A.PAU.21 (incorporated herein by reference), describes an example authentication mechanisms that ensures the security of event communication over the Internet. Together these support secure event communication involving CE devices over the Internet and through firewalls.

This description uses certain terminology to describe eventing. Eventing in the simplest case involves a source which generates events and a client which wants to be informed when the events occur. In the context of this description, source, server and publisher are interchangeably used to denote a source device/application; client, destination and subscriber are used interchangeably to denote a client device/application, and notification represents a message sent to notify a client about the occurrence of an event.

In some configurations, a third type of device/system is involved in eventing. These systems, called notification centers, are to manage event posting/publishing and notification. A notification center can be a standalone system or software on a multipurpose server such as a home gateway. From a notification center, a server asks for permission to publish events, and a client subscribes for receiving notifications for specified types of events from specified servers.

When an event occurs on the server, there are four example ways for the client to receive a notification: (1) the server publishes the event and sends a notification directly to the client, (2) the client polls for notifications directly from the server, (3) the server publishes the event on the notification center which sends a notification to the client, and (4) the server publishes the event on the notification center and the client polls the notification center for the notification.

According to an embodiment of the present invention, eventing is performed in two disjoint phases: a subscription phase followed by a notification phase. In cases where notification server and client directly communicate with each other, eventing between them proceeds as follows: In a subscription phase, a client (e.g., an application running on a home device that connects to the Internet directly) sends a subscription request to a server (e.g., a web site server or a device on the Internet) in an attempt to express its interest in receiving notifications associated with some events that may asynchronously occur on the server. After a successful subscription, the notification phase starts. In the notification phase, the server sends a notification to each and every client that has subscribed for a particular type of event.

In cases where a notification center is involved, eventing process proceeds according to the following steps. A client sends a subscription request to the notification center to ask for notifications for one or more events from one or more servers. After a successful subscription, the client polls the center for notification or the center pushes the notification to the client. Meanwhile, independently, a server sends a subscription request to ask for permission to publish events on the center. After a successful subscription, the server can then publish the events on the center as they occur. The center then makes sure that the clients that have subscribed for the notification will all receive a notification when a new event is published.

Eventing Schemes

As generally described, in one embodiment the present invention uses two types of methods for event communication: a direct method and an indirect method. The direct method uses a direct link between communicating parties. A TCP/IP link, an HTTP link are examples of direct links. In the following description, the term “direct link” represents such type of connection. Using a direct link requires a sender to know the receiver's address. For example, to use an HTTP link the sender must know the receiver's URL; to use a TCP link, the sender must know the IP address and the port number of the receiver (referred as the listener of the receiver). In the following description, the term “direct link address” represents such type of network addresses. The indirect method uses indirect links such as email. Using email requires the sender to know the receiver's email address. In the following, the term “email” represents indirect connection and addressing.

For ease of understanding, basic implementations of the eventing schemes according to the present invention are described herein. However, as those skilled in the art will recognize, such schemes are applicable also to any cases that involve more than one instance of any of the participating parties including servers, homes, devices, gateways, etc. Although in the description and figures the client device and server device are depicted separately for clarity, as those skilled in the art will recognize, such devices can be physically integrated in a single system, i.e. a system can behave as a client when it receives notification, and meanwhile it can behave as a server when it publishes event occurrences.

Scheme 1

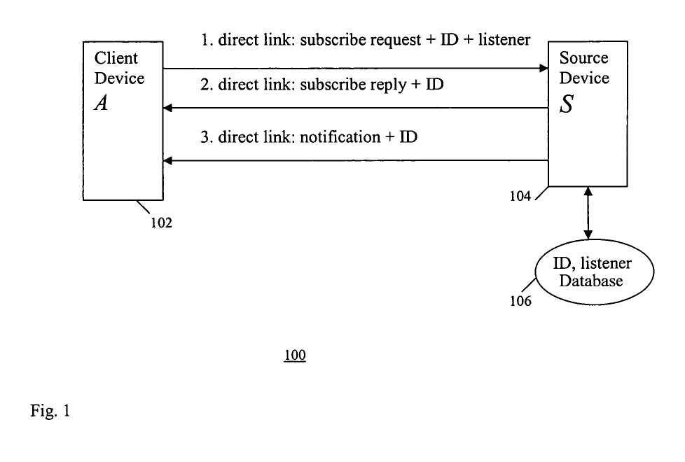

Referring to the example system 100 in FIG. 1, this scheme uses direct links for both subscription and notification, which in the simplest case involves two devices: a client device A (102) and a server device S (104) connected by a direct link (device S can be an ASP site). The scheme includes the following steps (shown as steps 1, 2, 3 in FIG. 1):
Step 1: Device A uses a direct link to send a request to subscribe a service from Device S on a LAN or on the Internet. Included in the request, Device A also sends a request ID and listener information. The request ID identifies the requested event type and the listener information tells the Device S where to send a reply to the request. An example of the request ID is an integer and an example of listener information is the direct link address of Device A.
Step 2: Device S sends a subscription reply to Device A indicating whether the subscription is successful. The reply message also includes the ID. If the subscription succeeds, Device S also stores the ID and the listener in a data storage indicated as the database 106 linked to Device S if any of them such as the listener and the ID that indicates the type of event Device A subscribes to, are not already in the storage. If the subscription failed, Device A may choose to log the information, prompt user actions, or retry the subscription, otherwise Device A is not required to do anything special. A listener can be device A itself, it can also be a different device such as the home gateway.
Step 3: At a later time, when an event corresponding to the request ID occurs on Device S, for each and every listener that has subscribed to the event, the Device S establishes a direct link using the direct link address of the listener and sends over a notification together with the ID to Device A. Upon receiving the notification, Device A processes the notification and might react accordingly. (Examples of processing: if the event indicates that there is a new song available, the notification receiver may play the song; if the event indicates a stranger's face at the home door, the receiver may make a sound and show the face to alarm the owner.)
   Scheme 2

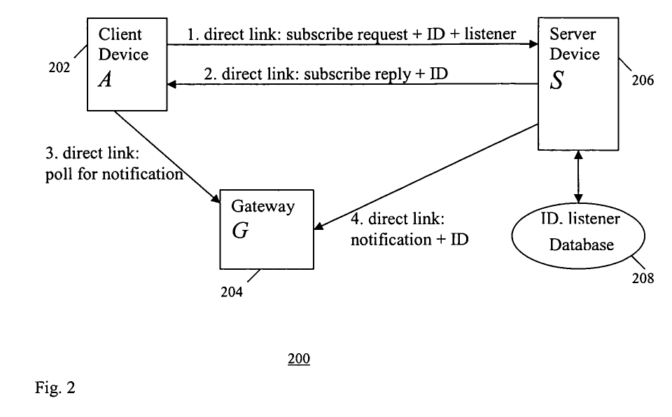

This scheme uses direct links for notification. As shown in example system 200 of FIG. 2, in the simplest case, this scheme involves a client device A (202) having a direct link to its home gateway G (204) through either a LAN or the Internet, and a source/server device S (206) which may be an ASP Web site. This scheme includes the following steps (shown as steps 1, 2, 3, 4 in FIG. 2):
Step 1: Device A uses a direct link to send a request to subscribe a service from Device S. Included in the request, Device A also sends a request ID, and listener information. The request ID identifies the requested event type and the listener information tells the server (Device S) where to send reply for the request. An example of the request ID is an integer and an example of listener information is the direct link address of the Gateway G.
Step 2: Device S sends a subscription reply to Device A indicating whether the subscription process is successful. The reply message also includes the ID. If the subscription succeeds, Device S also stores the ID and the listener in a data storage 208 indicated as the database linked to it if any of them such as the listener and the ID that indicates the type of event Device A subscribes to, are not already in the storage. If the subscription failed, Device A may choose to log the information, prompt user actions, or retry the subscription.
Step 3: If the subscription succeeded, Device A starts to poll for notifications from the gateway G using the direct link between them.
Step 4: At a later time, when an event corresponding to the ID occurs on Device S, for each and every listener that has subscribed to the event, the Device S establishes a direct link using the direct link address of the listener and sends over a notification together with the ID. After Device A receives the notification through polling in Step 3, it processes the notification.
   Scheme 3

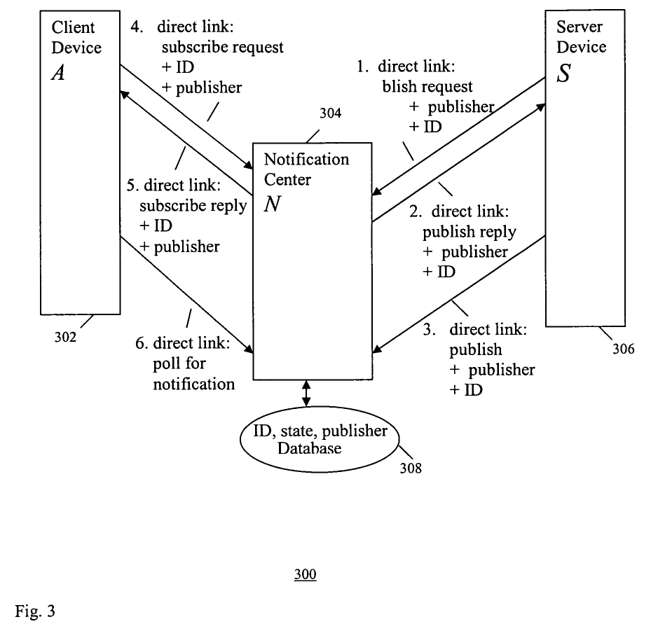

In this scheme, a notification center is involved in eventing, and all communicating parties use direct links for subscription, publication, and notification. As shown in the example system 300 in FIG. 3, in the simplest case, the embodiment involves a client device A (302), a notification center N (304) whose main function is to manage publication and notification of asynchronous events on the Internet, and a source device S (306) which may be an ASP site. This scheme includes the following two independent sets of steps (shown in FIG. 3, wherein steps 1, 2, 3, are independent from steps 4, 5, 6):
The set for publishers, i.e. for servers interested in publishing event occurrences:
Step 1: Device S uses a direct link to send a request to Notification Center N to ask permission to publish event occurrences on the center. Included in the request, Device S also sends a request ID and publisher information. The request ID identifies the type of events to be published, and the publisher information indicates the source of the events. An example of the request ID is an integer, and an example of publisher information is the URL of a source.
Step 2: Notification Center N sends a subscription reply to Device S indicating whether the request is granted. The reply message also includes the ID and the publisher. If the request is granted, Notification Center N also stores the ID and the publisher in a data storage 308 indicated as the database linked to it, if any of them such as the publisher and the ID that indicates the type of event Device A subscribes to, are not already in the storage. If the subscription failed, Device S may choose to log the information, prompt user actions, or retry the subscription.
Step 3: If the request is granted, Device S will send publishing messages to the notification center N when the events occur. Upon receiving the publication, the notification center N updates the state of the event identified by the ID and publisher.

The set for subscribers, i.e. for clients interested in receiving notifications: (Note: if step 4 specifies the publisher information, all the other steps must also include the publisher information. As such, in this sense, adding publisher information is a variation of embodiment.)
Step 4: Device A uses a direct link to send a request to Notification Center N to subscribe a service from Device S. Included in the request, Device A also sends a request ID and optionally the publisher information. The request ID identifies the requested event type, and the publisher information indicates the source of the events. An example of the request ID is an integer, and an example of publisher information is the URL of a source.
Step 5: Notification Center N sends a subscription reply to Device A indicating whether the subscription is successful. The reply message also includes the ID and the publisher information if this information was specified in the subscription request. If the subscription succeeds, Notification Center N also stores the ID and the publisher in a data storage indicated as the database 308 linked to it, if any of them such as the optional publisher and the ID that respectively indicate the source device and the type of event Device A subscribes to, are not already in the storage. If the subscription failed, Device A may choose to log the information, prompt user actions, or retry the subscription.
Step 6: If the subscription succeeded, Device A starts to poll for notification from the notification center. If the state of the event of interest has changed from the last poll, it processes the notification.
   Scheme 4

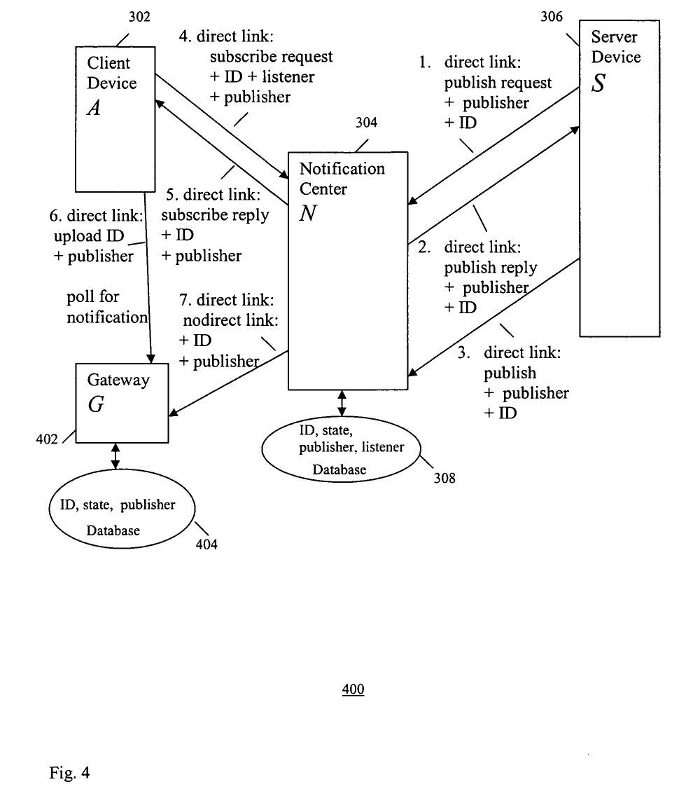

As shown in the example system 400 in FIG. 4, this scheme is similar to the Scheme 3 above except that Device A (302) is behind a home gateway G (402). As a result, Device A is not directly reachable from the Notification Center N. However, the Home Gateway G directly connects to the Internet, and therefore, connects to the Notification Center N. As a result, the Gateway G acts as a temporary events holder for the Device A. There are no changes for publisher's steps. The subscription and notification of Device A is changed as described in the following: (Note: if step 4 specifies the publisher information, all the other steps must also include the publisher information. As such, in this sense, adding publisher information is a variation of embodiment.)
Step 4: Device A uses a direct link to send a request to Notification Center N to subscribe a service from Device S. Included in the request, Device A also sends a request ID and listener information. The request ID identifies the requested event type, and the listener information indicates where the events should be sent to. An example of the request ID is an integer, and an example of listener information is the listening address of the Gateway G. Optionally, the request can also include the publisher ID to specify a device or application that generates the event.
Step 5: Notification Center N sends a subscription reply to Device A indicating whether the subscription is successful. The reply message also includes the ID and the publisher information if this information was specified in the subscription request. If the subscription succeeds, Notification Center N also stores the ID, the listener, and the optional publisher in a data storage indicated as the database 308 linked to it, if any of them such as the listener, the ID that indicates the type of event Device A subscribes to and the optional publisher, are not already in the storage. If the subscription failed, Device A may chose to log the information, prompt user actions, or retry the subscription.
Step 6: If the subscription succeeded, Device A uploads the ID and the optional publisher information to the gateway G and starts to poll for notification from the Gateway G.
Step 7: Whenever the Notification Center N receives new events from publishers, including the Device S, it uses the direct link to send the new events to the Gateway G.
   Scheme 5

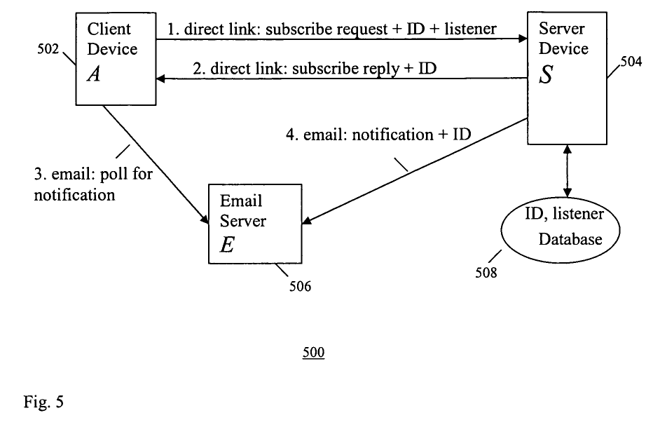

This scheme uses a direct link for subscription and an indirect link for notification. As shown by the example system 500 in FIG. 5, in the simplest case, this embodiment involves a client device A (502) which is behind a legacy home gateway (not shown in the figure), a server device S (504) which may be an ASP Web site. The server device S includes a database 508 that contains the device subscription information, such as who (e.g., listeners) is interested in what events. The scheme also contains an email server E (506) which may be linked to Server S via either a LAN or the Internet. This embodiment includes the following steps (shown in FIG. 5 as steps 1, 2, 3 and 4):
Step 1: Device A uses a direct link to send a request to subscribe a service from Device S on the Internet. Included in the request, Device A also sends a request ID, and listener information. The request ID identifies the requested event type and the listener information tells the server S where to send event when matched event occurs. An example of the request ID is an integer and an example of listener information is the email address of Client A.
Step 2: Device S sends a subscription reply to Device A indicating whether the subscription process is successful. The reply message also includes the ID. If the subscription succeeds, Device S also stores the ID and the listener in a data storage indicated as the database 508 linked to Device S, if any of them, such as request ID and listener information, are not already in the storage. If the subscription failed, Device A may chose to log the information, prompt user actions, or retry the subscription.
Step 3: If the subscription succeeded, Device A starts to poll for notification from the email server E via email.
Step 4: At a later time, when an event corresponding to the request ID occurs on Device S, Device S sends an email to Device A with the notification and the ID. After Device A receives the notification through polling in Step 3, it processes the notification.
   Scheme 6

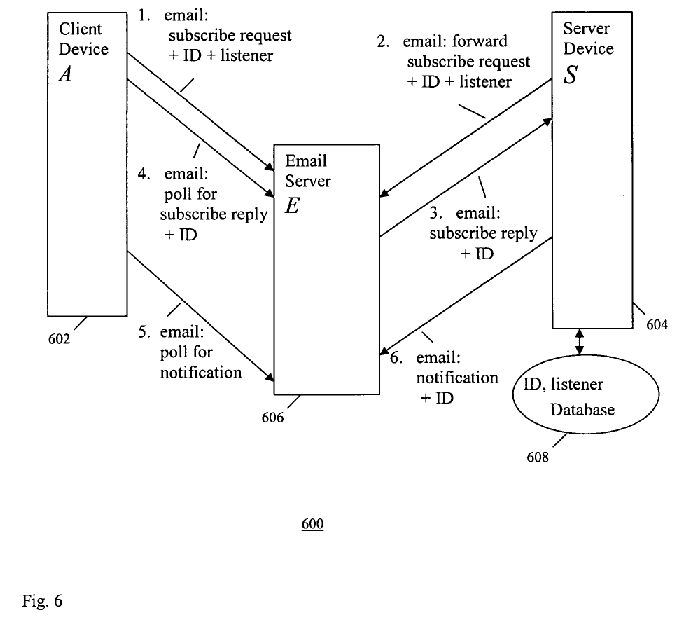

This scheme uses indirect links (email) for both subscription and notification. As shown by the example system 600 in FIG. 6, in the simplest case, this embodiment involves a client device A (602) which is behind a legacy home gateway (not shown in the figure), a server device S (604) which may be a device behind another legacy gateway, and an email server E (606) which may be linked to Device A and Server S separately via either a LAN or the Internet. This embodiment includes the following steps (shown in FIG. 6 as steps 1, 2, 3, 4, 5 and 6):
Step 1: Device A uses email to send a request to subscribe a service from Device S. Included in the request, Device A also sends a request ID, and listener information. The request ID identifies the requested event type and the listener information tells the server S where to send reply for the request, and where to send the event when it occurs. An example of the request ID is an integer and an example of listener information is the email address of Device A.
Step 2: Email Server E forwards the email to Server S.
Step 3: Server S sends a subscription reply to Device A indicating whether the subscription is successful. The reply message also includes the ID. If the subscription succeeds, Device S also stores the ID and the listener, such as Device A email address, in a data storage indicated as the database 608 linked to Device S, if any of them are not already in the storage.
Step 4: Device A polls the email from Email Server E for subscription reply.
Step 5: Device A examines the email. If the subscription succeeded, Device A starts to poll for notification from the email server E. If the subscription failed, Device A may choose to log the information, prompt user actions, or retry the subscription.
Step 6: At a later time, when an event corresponding to the request ID occurs on Device S, Device S sends an email to Device A with the notification and the ID using the listener information. After Device A receives the notification through polling in Step 5, Device A processes the notification.

Accordingly, an example eventing method (and system) according to the present for eventing over the Internet: (1) does not require any changes in the existing Internet infrastructure, which makes it easier to be deployed, (2) includes mechanisms to deliver notification to devices behind firewalls from anywhere on the Internet, (3) uses only widely accepted standards and does not depend on any particular service providers solutions, (4) enhances scalability by allowing a home gateway to be configured to host a notification center on behalf of all devices that belong to the home, (5) performs best-effort timely delivery for notification. This is accomplished by first classifying the events according to their urgency and delivering them accordingly. Urgent notifications are delivered using direct links between senders and receivers of a notification whenever possible, while non-urgent events are delivered using slower vehicles, such as email. The mechanism can be included in any forwarding intermediary devices such as home gateways and notification centers, as well as event source devices in order to ensure end-to-end direct link delivery when possible.

While the present invention has been described herein by example using the terminology of client-server, as those skilled in the art will recognize, the present invention is equally applicable in client-server, peer-to-peer, and other architectures. As such, the term “client” as used herein, can be replaced by “a first entity”, “event receiver”, “event destination”, “first node”, etc. Similarly, the term “server” as used herein, can be replaced by “a second entity”, “event sender”, “event source”, “second node”, etc. As such, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method for asynchronous eventing between a first node and a second node in a network, comprising the steps of:
in a subscription phase, the first node sending a subscription request to the second node to express interest in receiving notifications associated with one or more particular events that may asynchronously occur on the second node; and
after a successful subscription, in a notification phase, the second node notifying each first node that has subscribed for a particular type of event.

2. The method of claim 1, wherein the network includes multiple first nodes, such that:
the subscription phase further includes the steps of each first node sending a subscription request to the second node to express interest in receiving notifications associated with particular events that may asynchronously occur on the second node; and
the notification phase further includes the steps of, after successful subscription, the second node notifying each first node that has subscribed for a particular type of event.

3. The method of claim 1, wherein the network includes multiple servers, such that:
the subscription phase further includes the steps of the first node sending a subscription request to each second node to express interest in receiving notifications associated with particular events that may asynchronously occur on that second node; and
the notification phase further includes the steps of, after successful subscription, each second node notifying each first node that has subscribed for a particular type of event.

4. The method of claim 1, wherein when an asynchronous event occurs, the step of notification further include the steps of the second node sending a notification directly to the first node.

5. The method of claim 1, wherein when an asynchronous event occurs, the step of notification further include the steps of the first node polls for notifications directly from the second node.

6. The method of claim 1, wherein when an asynchronous event occurs, the step of notification further include the steps of the second node publishing the event on a notification center in the network, wherein the notification center sends a notification to the first node.

7. The method of claim 1, wherein when an asynchronous event occurs, the step of notification further include the steps of the second node publishing the event on a notification center in the network, wherein the first node polls the notification center for the notification.

8. The method of claim 1, wherein the second node notifies the first node via a direct communication link between the first node and the second node.

9. The method of claim 1, wherein the network further includes a notification center, such that:
the subscription phase further includes the steps of: the first node sending a subscription request to the notification center to request notifications for one or more events from one or more second nodes; and
the notification phase further includes the steps of: after a successful subscription, the first node polling the notification center for notification.

10. The method of claim 9 wherein in the notification phase, the notification center pushes the notification to the first node.

11. The method of claim 9 further including the steps of:
each second node sending a subscription request to the notification center for permission to publish events on the notification center;
after a successful server subscription, the second node publishing events on the notification center as they occur on the server; and
the notification center notifying each first node of published notifications that the first node subscribed for with the notification center.

12. The method of claim 11 wherein the notification center notifies each first node of published notifications that the first node subscribed for, as the event is published by the server.

13. The method of claim 1 wherein the second node and the first node use direct communication.

14. The method of claim 13 wherein the second node and the first node use a direct communication link between the second node and the first node for communication.

15. The method of claim 1 wherein the second node and the first node use indirect communication.

16. The method of claim 15 wherein the second node and the first node use an indirect communication link between the clink and the second node for communication.

17. The method of claim 1 wherein the network includes the Internet such that the first node and second node are connected to the Internet.

18. The method of claim 1 where in the network includes a local area network (LAN) such that the first node and the second node are connected to each other via LAN and the Internet using gateway(s).

19. An asynchronous eventing system, comprising: a first node and server, wherein the first node sends a request to a second node to request subscription to event notification for one or more particular events that may asynchronously occur on the second node, the request including request ID that identifies the requested event type, and listener information that identifies a listener for the second node to send a reply to the request; if the subscription is successful, the second node maintains the request ID and the listener information and sends a subscription reply including the request ID to the first node to indicate whether the subscription is successful, wherein if the subscription is successful, thereafter when an event corresponding to the request ID occurs on the server, for each and every listener that has subscribed to the event, the second node establishes a direct or indirect connection to the listener and sends a notification together with the request ID to the listener.

20. The system of claim 19, wherein the listener is listening address of the first node.
